(19) United States
(12) Patent Application Publication
(10) Pub. No.: US 2016/0071214 A1
(43) Pub. Date: Mar. 10, 2016

(54) SYSTEM AND METHOD FOR COMPELLING PHYSICAL DELIVERY OF ITEMS WITHIN A QUALITY RANGE

(71) Applicant: Chicago Mercantile Exchange, Inc., Chicago, IL (US)

(72) Inventors: John Labuszewski, Westmont, IL (US); Richard Co, Chicago, IL (US); Andrew Newman, New York, NY (US); Mike Kamradt, Flossmoor, IL (US); Fred Sturm, Chicago, IL (US)

(21) Appl. No.: 14/482,814

(22) Filed: Sep. 10, 2014

(51) Int. Cl. G06Q 40/06

(52) U.S. Cl. CPC G06Q 40/06

(57) ABSTRACT

Systems and methods are provided for processing futures contracts that have physical delivery settlement provisions. At the time of settlement, the quality of potential underlying items that would be delivered are ranked. The rankings may be based on characteristics of the sources of the potential underlying items. Subsets of the potential underlying items that comply with percentile ranges included in the futures contracts may then be identified as deliverable underlying items.

### FIELD OF THE INVENTION

Aspects of the invention relate to the delivery of items in deliverable futures contracts. More particularly, aspects of the invention relate to systems and methods for compelling delivery of items within a quality range.

### BACKGROUND

Futures contracts generally obligate buyers and sellers to purchase and sell an asset at a predetermined time and at a predetermined price. Assets may include physical commodities and financial instruments. Certificates of deposit are exemplary financial instruments. An exemplary futures contract is a short-term interest rate futures contract that requires delivery of a certificate of deposit.

Futures contracts can specify settlement by physical delivery or by cash. Settling a futures contract with physical delivery involves delivering the asset. For example, a quantity of corn or a certificate of deposit may be delivered to a specific location or a currency payment may be made to settle the futures contract. Alternatively, some futures contracts specify that they will be cash settled. Cash settlement may include a cash payment that is the difference between a spot price and the price specified by the futures contract.

For each multi-laterally traded futures contract, there is a long counterparty and a short counterparty. Generally, however, either the long or the short of each such contract is an exchange or clearinghouse. For example, a first counterparty may offer to sell a particular type of futures contract through an exchange. After the exchange publishes that offer, a second counterparty may purchase a futures contract of that type through the exchange at the offered price. The exchange then establishes a first contract in which the first counterparty is the short and the exchange clearinghouse is the long, and an offsetting second contract in which the second counterparty is the long and the exchange is the short, with the contract price of the first and second contracts (the accepted offer price of the first counterparty) being the same. The first and second counterparties do not know each other's identities.

As also indicated above, some types of futures contracts are “physically” settled, i.e., the short counterparty agrees to deliver the actual commodity at final settlement. In some cases, the short may do so by literally providing the contract amount of the quantity to a location specified by the contract (e.g., delivery of crude oil to an oil terminal, delivery of grain to a grain elevator). In other cases, the short may deliver the contracted-for commodity by providing documents (e.g., warehouse receipts representing commodities in storage) or other evidence establishing that the contracted-for amount of the quantity has been provided (e.g., data confirming transfer of a note, bond, stock or other financial instrument to a specified account). Some physical settlements can involve transfer of money. For example, a foreign currency futures contract could require transfer of a contract amount of a foreign currency (e.g., Euros, Yen, etc.) at final settlement in return for payment of the contract price in a different currency (e.g., U.S. Dollars).

Existing futures contracts that call for the physical delivery of underlying assets provide the parties responsible for delivering the underlying assets with incentives to find the cheapest to deliver assets. The cheapest to deliver assets are often the lowest quality assets. For example, a futures contract may call for the delivery of a certificate of deposit issued from a group of banks. At the time of delivery a certificate of deposit issued by a bank with the lowest credit rating may be the cheapest to deliver. Some prior art approaches have tried to address this problem by providing for financial adjustments based on quality at the time of deliver. Other prior art approaches have used conversion factors to account for varying coupons and maturities of Treasury financial instruments.

Accordingly, there is a need in the art for futures contracts systems and methods for compelling delivery of items within a quality range.

### SUMMARY OF THE INVENTION

Aspects of the invention overcome at least some of the problems and limitations of the prior art by providing systems and methods for ranking and selecting underlying items that may be delivered in accordance with terms of futures contracts. First, a group of potential underling items identified in a futures contract may be identified. Next, the quality of the potential underlying items are ranked to generate quality rankings for each of the potential underlying items. After the potential underlying items are ranked, a subset of the potential underlying items are determined that satisfy a minimum quality ranking to identify deliverable underlying items. Futures contracts may be settled with the deliverable underlying items.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a method of processing futures contracts that call for the physical delivery of underlying items in accordance with an embodiment of the invention.

FIG. 3 illustrates a system for processing futures contracts that call for the physical delivery of underlying items in accordance with an embodiment of the invention.

### DETAILED DESCRIPTION

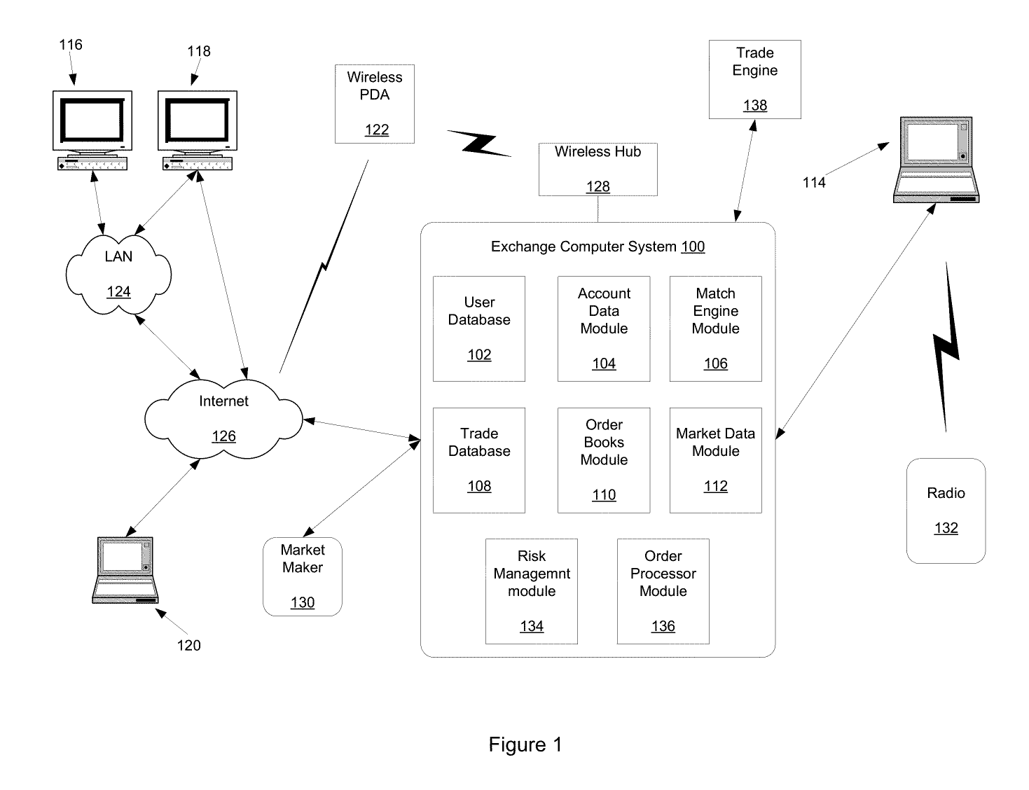

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

Various embodiments of the invention process or utilize futures contracts that have quality standards that are applied at the time of delivery of underlying assets. Criteria for ranking the quality of available underlying assets may be included in the futures contracts. The futures contracts may also include a minimum or a range of quality levels required at the time of delivery.

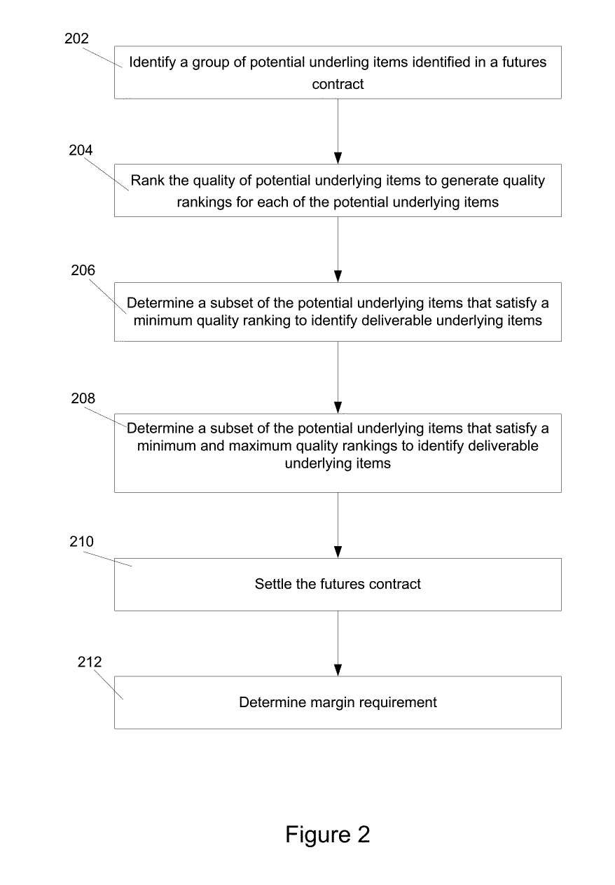

FIG. 2 illustrates a method of processing futures contracts that call for the physical delivery of underlying items in accordance with an embodiment of the invention. First, in step 202 a group of potential underlying items identified in a futures contract are identified. The futures contract may list the group of potential underlying items or identify sources of the potential underlying items. In some embodiments a computer device may be programmed to search a wide area network, such as the Internet, to locate potential underlying items.

Next, in step 204, the quality of potential underlying items are ranked to generate quality rankings for each of the potential underlying items. Step 204 may be performed by one or more computer processors and may consider characteristics of sources of the potential underlying items. Factors that may be considered when ranking potential underlying items include credit worthiness of sources, revenue of sources, profitability of sources, transaction volume and other factors relating to the quality of the potential underlying items. In some embodiments surveys are distributed and results are analyzed as part of the ranking process. One or more computer processors may be programmed to analyze the survey results. Or course, some embodiments may use a combination of factors when ranking potential underlying items. Step 204 may include assigning quality percentile rankings to each of the potential underlying items.

The ranking process may be performed at the time of settlement to ensure that current information is being used when selecting potential underlying items.

After the rankings are determined, in step 206 a subset of the potential underlying items that satisfy a minimum quality ranking are determined to identify deliverable underlying items. Step 206 may include selecting potential underlying items with a minimum percentile ranking, such as the 25^{th} percentile. Other embodiments may include selecting potential underlying items with a percentile ranking within a range, such as the 25^{th} to the 75^{th} percentile.

In step 210 the futures contract is settled. Step 210 may include using a processor computer-executable instructions to select one of the deliverable underlying items based on the rankings and possible other factors like preferences of one or both of the parties to the futures contract. One or more additional steps may also be performed by an exchange, clearinghouse or other entity. For example, in step 212 a margin requirement may be determined.

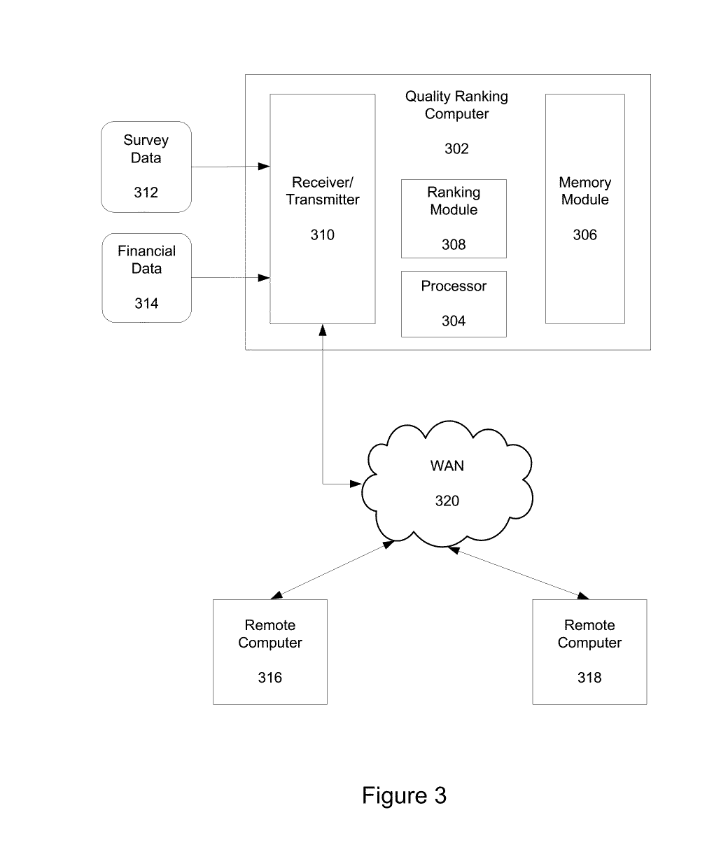

FIG. 3 illustrates a system for processing futures contracts that call for the physical delivery of underlying items in accordance with an embodiment of the invention. A quality ranking computer 302 may include a processor 304 and a memory module 306. Memory module 306 may store computer-executable instructions that implement methods disclosed herein when executed by processor 304. A ranking module 308 may be used to rank potential underlying items. In various embodiments ranking module 308 is implemented with computer-executable instructions and/or a processor. In some embodiments ranking module is implemented with computer-executable instructions stored in memory module 306 or processor 304.

A receiver/transmitter 310 may be configured to receive data that may be used in a ranking process. Exemplary data includes survey data 312 and financial data 314. Receiver/transmitter 310 may also communicate with remote computers, such as remote computer 316 and remote computer 318 via a wide area network, such as the Internet. In some embodiments remote computers 316 and 318 provide data to quality ranking computer 302 and/or receive ranking data from quality ranking computer 302. Receiver/transmitter 310 may be implemented with a network interface controller, integrated circuit or other components configured to receive and/or transmit data.

The present invention has been described in terms of preferred and exemplary embodiments thereof. Numerous other embodiments, modifications and variations within the scope and spirit of the invention will occur to persons of ordinary skill in the art from a review of this disclosure.

We claim:

1. A method comprising:
(a) identifying a group of potential underlying items identified in a futures contract;
(b) ranking by a processor the quality of potential underlying items to generate quality rankings for each of the potential underlying items; and
(c) determining by a processor a subset of the potential underlying items that satisfy a minimum quality ranking to identify deliverable underlying items.

2. The method of claim 1, wherein the potential underlying items comprise financial instruments.

3. The method of claim 2, wherein the financial instruments comprise certificates of deposit.

4. The method of claim 1, wherein (b) comprises analyzing survey data.

5. The method of claim 1, wherein (b) comprises considering characteristics of sources of the potential underlying items.

6. The method of claim 5, wherein (b) comprises considering credit worthiness of sources of the potential underlying items.

7. The method of claim 5, wherein (b) comprises considering revenue of sources of the potential underlying items.

8. The method of claim 5,wherein (b) comprises considering profitability of sources of the potential underlying items.

9. The method of claim 5, wherein (b) comprises considering transaction volumes of sources of the potential underlying items.

10. The method of claim 5, wherein (b) comprises considering a combination of factors relating to credit worthiness and profitability of sources of the potential underlying items.

11. The method of claim 1, wherein (b) is performed at a time of settlement of the futures contract.

12. The method of claim 1, wherein the deliverable underlying assets have a minimum quality ranking at least in the 25 percentile of potential underlying items.

13. The method of claim 1, wherein (c) comprises determining by a processor a subset of the potential underlying items that satisfy a minimum quality ranking and a maximum quality ranking to identify deliverable underlying items.

14. The method of claim 1, wherein the deliverable underlying assets have a minimum quality ranking at least in the 25 percentile of potential underlying items and a maximum quality ranking at most in the 75 percentile of potential underlying items.

15. A system comprising
a receiver that receives information relating to a group of potential underlying items identified in a futures contract;
a ranking module configured to rank the quality of potential underlying items to generate quality rankings for each of the potential underlying items; and
a processor configured to execute computer-executable instructions to determine a subset of the potential underlying items that satisfy a minimum quality ranking to identify deliverable underlying items.

16. The system of claim 15, wherein the potential underlying items comprise financial instruments.

17. The system of claim 15, wherein the ranking module is configured to rank the quality of potential underlying items to generate quality rankings for each of the potential underlying items by considering characteristics of sources of the potential underlying items.

18. The system of claim 17, wherein characteristics of sources of the potential underlying items include credit worthiness of sources of the potential underlying items.

19. A tangible non-transitory computer-readable medium containing computer executable instructions that when executed cause a computer device to perform the steps comprising:
(a) identifying a group of potential underlying items identified in a futures contract;
(b) ranking the quality of potential underlying items to generate quality rankings for each of the potential underlying items; and
(c) determining a subset of the potential underlying items that satisfy a minimum quality ranking to identify deliverable underlying items.

20. The tangible non-transitory computer-readable medium of claim 19, wherein (b) comprises considering characteristics of sources of the potential underlying items.
